(19) United States
(12) Patent Application Publication
(10) Pub. No.: US 2026/0062041 A1
(43) Pub. Date: Mar. 5, 2026

(54) HAND TRUCK

(71) Applicant: Chung-Hsiu SU, Kaohsiung City (TW)

(72) Inventor: Chung-Hsiu SU, Kaohsiung City (TW)

(21) Appl. No.: 18/823,193

(22) Filed: Sep. 3, 2024

(51) Int. Cl. B62B 1/14

(52) U.S. Cl. CPC B62B 1/142; B62B 2203/24

(57) ABSTRACT

A hand truck includes a main frame unit configured to carry an article, two spaced-apart clamping arm units pivotally disposed on a bottom end of the main frame unit, and two elastic restoring members connected between the main frame unit and one of the clamping arm units. The clamping arm units are driven to move relative to the main frame unit between a clamped position, in which the clamping arm units are moved close to each other for clamping therebetween the article carried by the main frame unit, and an open position, in which the clamping arm units are moved away from each other. A step mechanism is pivotally disposed on the main frame unit, and is configured to be stepped on and pressed down by a foot of a user to drive the clamping arm units to move toward the open position.

### FIELD

The disclosure relates to a transport vehicle, and more particularly to a hand truck.

### BACKGROUND

A conventional hand truck generally includes a frame, a wheel unit mounted to the bottom of the frame, and a shovel plate disposed on a bottom portion of the frame. The shovel plate is first used to shovel an article placed on the ground, after which the frame is disposed inclinedly and rearwardly so that the carried article can lean back against the frame, and finally, the article can be transported through the wheel unit.

However, the problem of using the conventional hand truck is that either the shovel plate cannot smoothly shovel the article placed on the ground, or the article cannot be stably pushed back against the frame. In either case, a user often has to use his/her hands to assist in stabilizing the article. When the user uses his/her hands to assist in stabilizing the article, this can cause considerable danger to the user. If there are sharp structures on surfaces of the article, the sharp structures may prick or pierce the hands of the user; and if the article is too heavy, use of the user's hands to assist in stabilizing the article is not only detrimental to the overall application of force, but also may cause injuries due to improper application of force. The most ergonomic and safest way to use the hands of the user is for controlling and stabilizing the frame.

### SUMMARY

Therefore, an object of the present disclosure is to provide a hand truck that can alleviate at least one of the drawbacks of the prior art.

According to this disclosure, the hand truck suitable for transporting an article includes a main frame mechanism, a clamping mechanism, and a step mechanism. The main frame mechanism includes a main frame unit extending in a top-bottom direction and configured to carry the article, and a wheel unit connected to the main frame unit for moving the main frame unit. The clamping mechanism includes two clamping arm units pivotally disposed on a bottom end of the main frame unit and spaced apart from each other in a left-right direction, and two elastic restoring members connected between the main frame unit and a corresponding one of the clamping arm units. The clamping arm units are driven to move relative to the main frame unit between a clamped position, in which the clamping arm units are moved close to each other for clamping therebetween the article carried by the main frame unit, and an open position, in which the clamping arm units are moved away from each other. The elastic restoring members constantly bias the clamping arm units toward the clamped position. The step mechanism is pivotally disposed on the main frame unit, is opposite to the clamping arm units in a front-rear direction, and is configured to be stepped on and pressed down by a foot of a user to drive the clamping arm units to move toward the open position.

### BRIEF DESCRIPTION OF THE DRAWINGS

Other features and advantages of the disclosure will become apparent in the following detailed description of the embodiment with reference to the accompanying drawings. It is noted that various features may not be drawn to scale.

FIG. 1 is a perspective view of a hand truck according to an embodiment of the present disclosure.

FIG. 2 is a fragmentary rear view of the embodiment.

FIG. 3 is a fragmentary side sectional view of the embodiment.

FIG. 4 is a fragmentary top sectional view of the embodiment, illustrating two clamping arm units in a clamped position.

FIG. 5 is a view similar to FIG. 3, but with a step member of a step mechanism being stepped on and pressed downward.

FIG. 6 is a view similar to FIG. 4, but with the clamping arm units in an open position.

### DETAILED DESCRIPTION

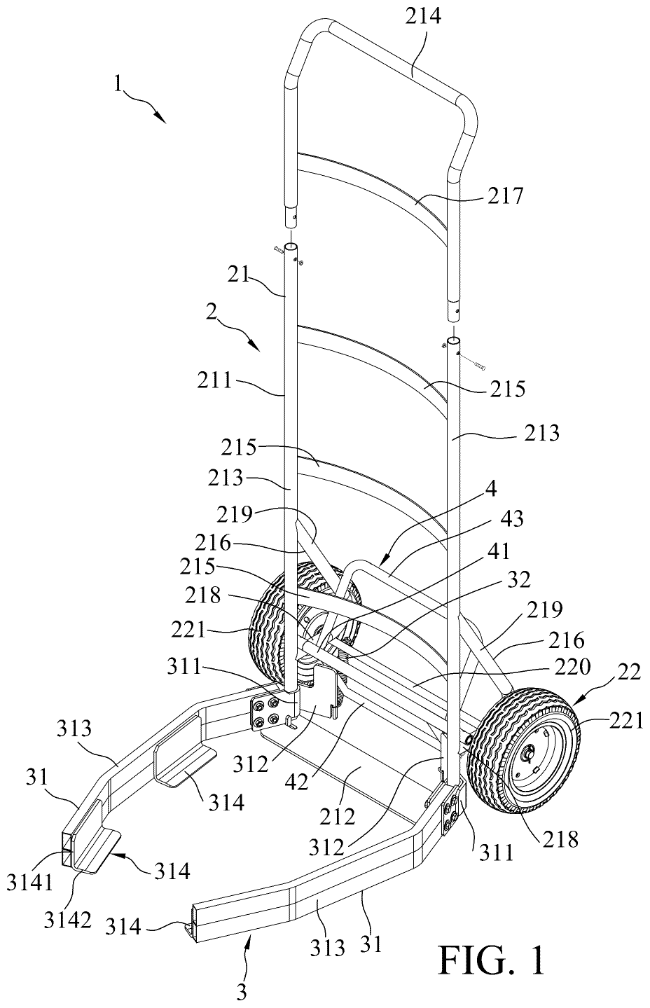

Referring to FIGS. 1 to 3, a hand truck 1 according to an embodiment of the present disclosure is suitable for transporting an article (not shown) placed on the ground, and includes a main frame mechanism 2 for carrying the article, a clamping mechanism 3 pivotally disposed on the main frame mechanism 2, and a step mechanism 4 pivotally disposed on the main frame mechanism 2 and opposite to the clamping mechanism 3 in a front-rear direction.

The main frame mechanism 2 includes a main frame unit 21 extending in a top-bottom direction for carrying the article, and a wheel unit 22 connected to the main frame unit 21 for moving the same. The main frame unit 21 includes a main frame body 211 extending in the top-bottom direction, and a shovel plate 212 extending forwardly from a bottom end of the main frame body 211 for shoveling and carrying the article. The main frame body 211 includes two support rods 213 extending in the top-bottom direction and spaced apart in a left-right direction, a substantially U-shaped handle member 214 having two opposite ends connected detachably and respectively to top ends of the support rods 213 such that the handle member 214 extends across the top ends of the support rods 213, three cross bars 215 connected to and extending across the support rods 213 and curving slightly rearward, and two bent rods 216 respectively connected to and extending rearwardly from bottom end portions of the support rods 213. The handle member 214 facilitates pushing and pulling of the main frame body 211 by a user. The cross bars 215 are spaced apart from each other along the lengths of the support rods 213, are located below the handle member 214, and are used for supporting the article when the article lean back against the main frame body 211.

The handle member 214 further has a handle cross bar 217 connected to and extending across two opposite sides thereof and curving slightly rearward. The handle cross bar 217 is also used for supporting the article when the article lean back against the main frame body 211. In this embodiment, each bent rod 216 has a rear extending section 218 connected to and extending rearwardly from the bottom end portion of the respective support rod 213, and an inclined extending section 219 bending and extending forwardly, inclinedly and upwardly from a rear end of the rear extending section 218 and connected to the bottom end portion of the respective support rod 213.

The wheel unit 22 has a shaft 220 connected to and extending across the bent rods 216, and two wheels 221 rotatably connected to two opposite ends of the shaft 220.

The clamping mechanism 3 includes two clamping arm units 31 and two elastic restoring members 32. The clamping arm units 31 are respectively disposed on bottom ends of the support rods 213, are pivotable leftward and rightward relative to the support rods 213, and are located above the shovel plate 212. Specifically, each clamping arm unit 31 includes a pivot connecting member 311 pivotally disposed on the bottom end of the respective support rod 213, a push member 312 connected to the pivot connecting member 311 and protruding toward the other clamping arm unit 31, a clamping arm body 313 fastened to the pivot connecting member 311 and extending forwardly and then bent inwardly toward the other clamping arm unit 31, and two spaced-apart limiting plates 314 connected to the clamping arm body 313 for shoveling and carrying the article. In this embodiment, the push member 312 has a substantially L-shaped body, and protrudes inclinedly, inwardly and rearwardly from the pivot connecting member 311; and the clamping arm body 313 is located in front of the shovel plate 212, and is opposite to the push member 312 in the front-rear direction. Furthermore, each limiting plate 314 has an L-shaped body, and includes a vertical plate 3141 fixed to an inner surface of the clamping arm body 313, and a horizontal plate 3142 connected to and extending transversely and inwardly from a bottom end of the vertical plate 3141.

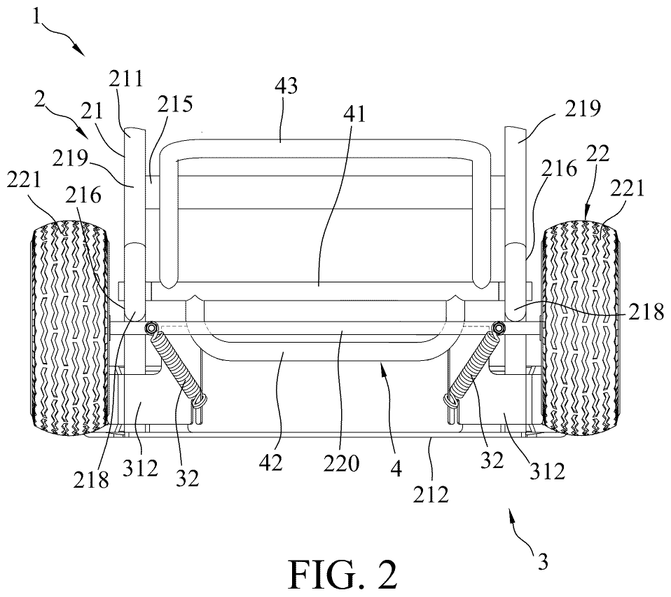

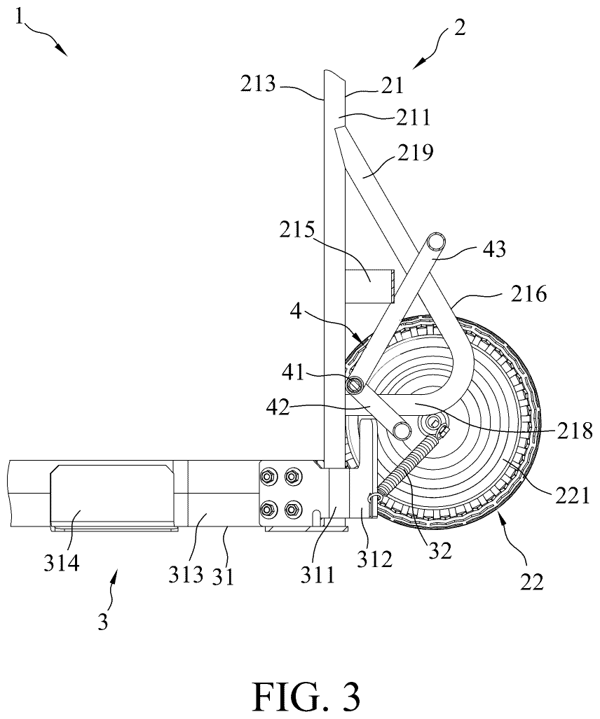

Each elastic restoring member 32 of this embodiment is a tension spring. However, in other embodiments of this disclosure, each elastic restoring member 32 may be made of an elastic rubber material. In this embodiment, each elastic restoring member 32 is connected between the main frame unit 21 and a corresponding one of the clamping arm units 31. Specifically, as shown in FIGS. 2 and 3, each elastic restoring member 32 has a front end fixed to a free end of one of the push members 312, and a rear end fixed to the shaft 220 of the wheel unit 22 and adjacent to one of the wheels 221. The elastic restoring members 32 provide elastic forces that bias the clamping arm units 31 to move toward each other.

The step mechanism 4 includes a rotary shaft 41 rotatably mounted between the bottom end portions of the support rods 213 and located above the rear extending sections 218 of the bent rods 216, a push member 42 that has two opposite ends connected to the rotary shaft 41, that extends downwardly, inclinedly, and rearwardly from the rotary shaft 41, and that abuts against rear ends of the push members 312 of the clamping arm units 31, and a stepping member 43 that has two opposite ends connected to the rotary shaft 41, that extends upwardly, inclinedly and rearwardly from the rotary shaft 41, and that is located above the push member 42. In this embodiment, each of the push member 42 and the stepping member 43 is substantially U-shaped.

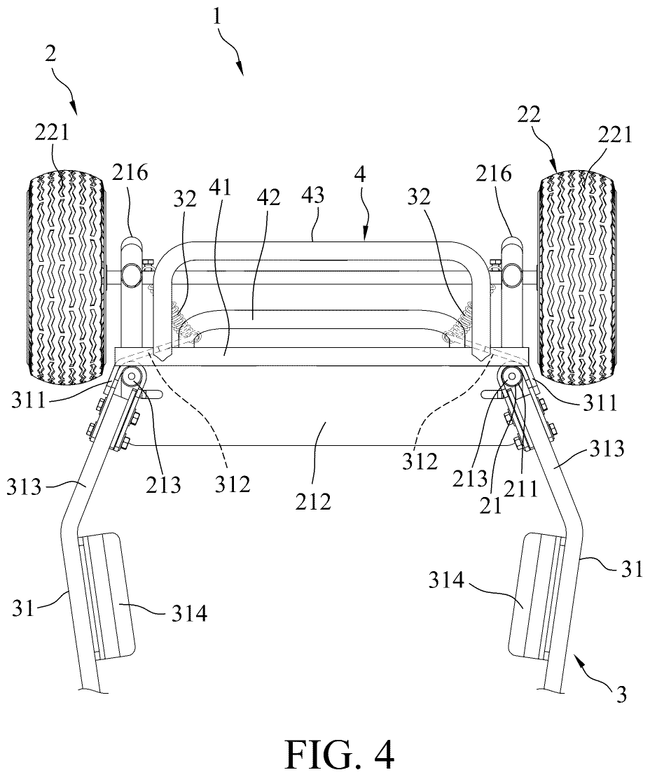

Referring to FIGS. 4 to 6, in combination with FIG. 3, the stepping member 43 is configured to be stepped on and pressed down by a foot of the user to drive the rotary shaft 41 to rotate, which in turn, drives the push member 42 to move forwardly.

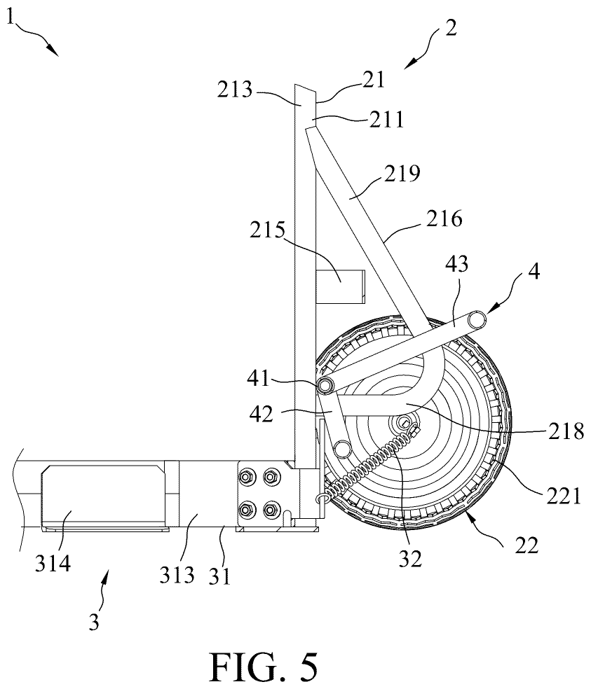

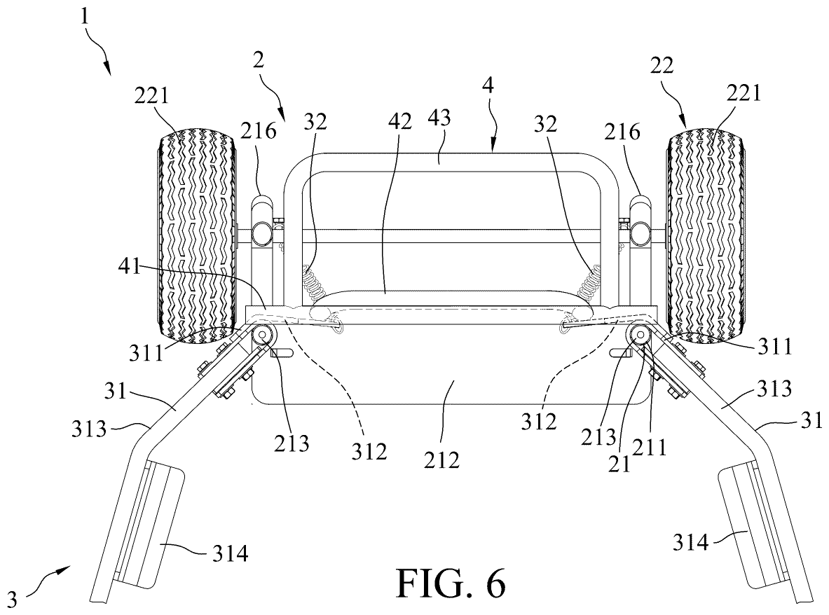

The clamping arm units 31 can be driven by the step mechanism 4 to move relative to the main frame unit 21 between a clamped position and an open or unclamped position. In the clamped position, as shown in FIGS. 1, 3 and 4, the clamping arm units 31 are moved close to each other so as to clamp the article (not shown) carried by the main frame unit 21. In the open position, as shown in FIGS. 5 and 6, the clamping arm units 31 are moved away from each other. When the stepping member 43 is stepped on and pressed down by the foot of the user, the clamping arm units 31 are shifted from the clamped position to the open position. That is, when the stepping member 43 is stepped on and pressed down by the foot of the user, the push member 42 pushes the push members 312 to move forwardly so as to respectively drive the pivot connecting members 311 to pivotally rotate relative to the support rods 213, and the pivot connecting members 311, in turn, respectively drive the clamping arm bodies 313 to move away from each other in the left-right direction, thereby shifting the clamping arm units 31 from the clamped position to the open position. When the clamping arm units 31 are in the open position, the elastic restoring members 32 are stretched by the push members 312 to store restoring forces for restoring the push members 312 to their original positions shown in FIGS. 1 and 4.

To operate the hand truck 1 for carrying the article placed on the ground, the hand truck 1 is first moved close to the article, after which the stepping member 43 is pressed down by the foot of the user to drive the clamping arm units 31 from the clamped position to the open position. Then, the hand truck 1 is pushed forwardly toward the article so as to insert the shovel plate 212 to a bottom end of the article, and the foot of the user is moved away from the stepping member 43, causing the clamping arm units 31 to elastically clamp the article and the horizontal plates 3142 of the limiting plates 314 to insert into the bottom end of the article. Finally, the main frame unit 21 can be tilted rearwardly with the wheels 221 as fulcrums so that the article can lean back against the main frame body 211 and be supported by the cross bars 215. The shovel plate 212 and the limiting plates 314 support the bottom end of the article at this time. The hand truck 1 can then be pushed forward or pulled rearward for transporting the article to a predetermined location.

Through the structural design of the limiting plates 314 of the clamping arm units 31, the horizontal plates 3142 of the limiting plates 314 can be inserted into the bottom end of the article, and can cooperate with the shovel plate 212 to shovel the article so as to facilitate the main frame unit 21 to carry the article. Furthermore, through the structural design of the elastic restoring members 32 and the clamping arm units 31, the clamping arm units 31 can elastically clamp the article, so that, when the article is shoveled by the shovel plate 212 and the limiting plates 314, the article can be prevented from falling sideways during transport. Moreover, the elastic restoring members 32 can constantly bias the clamping arm units 31 toward the clamped position.

In summary, through the structural design of the clamping mechanism 3 and the step mechanism 4 of the hand truck 1 of this disclosure, the user can use his/her foot to control the clamping arm units 31 to clamp the article, so that the main frame unit 21 can stably shovel and carry the article. Through this, injuries caused by using the user's hands to assist in stabilizing the article can be avoided. Hence, the hand truck 1 of this disclosure is safe to use. Furthermore, through the structural design of the elastic restoring members 32, the clamping arm units 31 can elastically clamp the article. Moreover, through the structural design of the limiting plates 314 of the clamping arm units 31, the shoveling and carrying of the article by the main frame unit 21 can be facilitated. Therefore, the hand truck 1 of this disclosure is a very practical creation, and can indeed achieve the object of this disclosure.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A hand truck suitable for transporting an article, comprising:
a main frame mechanism including a main frame unit extending in a top-bottom direction and configured to carry the article, and a wheel unit connected to said main frame unit for moving said main frame unit;
a clamping mechanism including two clamping arm units pivotally disposed on a bottom end of said main frame unit and spaced apart from each other in a left-right direction, and two elastic restoring members connected between said main frame unit and a corresponding one of said clamping arm units, said clamping arm units being driven to move relative to said main frame unit between a clamped position, in which said clamping arm units are moved close to each other for clamping therebetween the article carried by said main frame unit, and an open position, in which said clamping arm units are moved away from each other, said elastic restoring members constantly biasing said clamping arm units toward said clamped position; and
a step mechanism pivotally disposed on said main frame unit and opposite to said clamping arm units in a front-rear direction, said step mechanism being configured to be stepped on and pressed down by a foot of a user to drive said clamping arm units to move toward said open position.

2. The hand truck as claimed in claim 1, wherein each of said clamping arm units includes a pivot connecting member pivotally disposed on said bottom end of said main frame unit, a push member connected to said pivot connecting member and protruding toward the other one of said clamping arm units, and a clamping arm body fixedly connected to and protruding forwardly from said pivot connecting member, and wherein, when said step mechanism is stepped on and pressed down by the foot of the user, said step mechanism pushes said push members of said clamping arm units to move forwardly so as to respectively drive said pivot connecting members of said clamping arm units to pivotally rotate relative to said main frame unit, said pivot connecting members of said clamping arm units respectively driving said clamping arm bodies of said clamping arm units to move away from each other when driven to pivotally rotate by said push members of said clamping arm units so as to shift said clamping arm units from said clamped position to said open position.

3. The hand truck as claimed in claim 2, wherein said step mechanism includes a rotary shaft rotatably mounted on said main frame unit, a push member connected to said rotary shaft and abutting against rear ends of said push members of said clamping arm units, and a stepping member connected to said rotary shaft and located above said push member of said step mechanism for the user to step on.

4. The hand truck as claimed in claim 2, wherein each of said clamping arm units further includes at least one limiting plate connected to and extending transversely from said clamping arm body for shoveling and carrying the article.

5. The hand truck as claimed in claim 1, wherein said main frame unit includes a main frame body extending in the top-bottom direction, and a shovel plate extending forwardly from a bottom end of said main frame body for shoveling and carrying the article.

6. The hand truck as claimed in claim 5, wherein said main frame body includes two support rods extending in the top-bottom direction and spaced apart in the left-right direction, said clamping arm units being disposed pivotally and respectively on bottom ends of said support rods.

7. The hand truck as claimed in claim 6, wherein said main frame body further includes a handle member connected to and extending across top ends of said support rods, and at least one cross bar connected to and extending across said support rods and located below said handle member.

8. The hand truck as claimed in claim 6, wherein said main frame body further includes two bent rods respectively connected to and extending rearwardly from bottom end portions of said support rods, each of said bent rods having two opposite ends connected to said bottom end portion of a respective one of said support rods, said step mechanism being pivotally disposed between said support rods.

9. The hand truck as claimed in claim 8, wherein each of said bent rods has a rear extending section connected to and extending rearwardly from said bottom end portion of said respective one of said support rods, and an inclined extending section bending and extending forwardly, inclinedly and upwardly from a rear end of said rear extending section and connected to said bottom end portion of said respective one of said support rods.
